(19) United States
(12) Patent Application Publication
(10) Pub. No.: US 2024/0151569 A1
(43) Pub. Date: May 9, 2024

(54) CONSUMABLE USAGE MEASUREMENT USING SOUND, TEMPERATURE, AND CENTRALIZED ANALYTICS

(71) Applicants: Guy Russell Van Buskirk, GRAPEVINE, TX (US); John Joseph Nadaskay, Addison, TX (US)

(72) Inventors: Guy Russell Van Buskirk, GRAPEVINE, TX (US); John Joseph Nadaskay, Addison, TX (US)

(21) Appl. No.: 18/054,126

(22) Filed: Nov. 9, 2022

(51) Int. Cl. G01F 15/063; G01F 1/66; G01M 3/28

(52) U.S. Cl. CPC G01F 15/063; G01F 1/666; G01M 3/2807

(57) ABSTRACT

In a method of estimating water consumption of a fixture which uses water, measurements of at least two of ambient sound, contact sound, and temperature are captured via a sensor assembly disposed proximate the fixture. From the captured measurements both a number of uses of the fixture and a duration of use each of the uses of the fixture are determined. Based on the number of uses and duration of the uses, water consumed by the fixture and consumables used in conjunction with the fixture are estimated.

### BACKGROUND

Consumption of natural resources and consumable packaged goods is becoming environmentally and economically expensive as natural resources become less plentiful and product-related energy costs increase. Mining and harvesting natural resources costs money and creates environmental damage through production of greenhouse gases. Packaged goods are manufacturing intensive and create waste in the form of tons of garbage. Water consumption and sewage generation are a focus of conservation as aquifers run low and rain patterns change. While education and large-scale, lagging indicators provide support for conservation, there is a gap in real-time feedback and accounting for assisting conservation at a personal, household, or facility level.

### SUMMARY

Measuring consumption of water, sewage, and household consumables enables identification of usage patterns and analysis of how those patterns compare to usage patterns of best-practice usage. Real-time measurement of consumption and near-real-time feedback of comparative usage patterns allow modification of usage behaviors and improves the responsible usage of resources through educating the consumer. Additionally, measurement and analytics for consumption of products such as dish soaps, laundry soaps, dishwasher soaps, rinse agents, cleaning supplies, shampoos, and other readily consumed products allow efficient and timely product replenishments without the need to rush-buy or ‘do without’ if consumables run dry. In one example, consumption measurements may be sent to a third party such as a product manufacturer or distributor for analysis of how products are used and how consumption may be optimized for various households or facilities. In another example, understanding the consumption of products and resources allows timely replenishment and just-in-time automated ordering of replacement consumables. Adding reports, recommendations, and alerts regarding consumption along with complete history and progress reports for conservation and proper usage educates and inspires the consumer to use the resources available more efficiently.

The technology and techniques disclosed herein use multiple methods to determine usage and analyze patterns of usage for generation of, or comparison to, optimal usage patterns. The system of Internet of Things (IoT) sensors and computational intelligence focuses on water valve usage and user behaviors relative to those valves. For example, measuring water usage at a sink may help identify if someone is running the water while shaving or brushing teeth, hence wasting water. Measuring water usage in the kitchen may help identify if users are wasting water hand-washing dishes vs. allowing the dishwasher to clean the dishes more economically. Measuring water temperature allows the inclusion of calculations for usage of hot water and the hence the consumption of both water and the energy used to heat the water. The ambient sounds associated with running water can assist in identifying the activity in process or the type of products being consumed, how often they are consumed, and even how much is being consumed.

Monitoring audible, sub-audible, and ultrasonic sounds through the air (ambient sound monitoring), in conjunction with monitoring the spectrum of sounds and vibrations conducted through a pipe, yields a rich set of data that can be analyzed to determine which nearby valve is open, percentage of openness, if a valve is not closed or may be leaking, which appliances are operating and on what cycle, and/or what activities are underway that might consume packaged goods. Additional sound-based information may be available by sensors strategically located in drain systems and sewage lines. Suspending a microphone in a household drain line provides information that can be analyzed for estimating drain flow as a proxy for water usage, or for determining the specific cycle that may be occurring in a toilet, dishwasher, clothes washer, or other appliance. Drain sounds may also indicate partial or complete drain blockages and may help determine where the blockage exists.

Certain water leaks may be detected by the sounds or vibrations of nearby valves, appliances, or toilets. A valve that is not sufficiently closed may make a squeaky sound or the drain may indicate a slow trickle of water through the drainage system. Sounds associated with a toilet may be analyzed to determine if the toilet fill & flush mechanism is properly operating, if the fill valve is leaking, or if the flapper is leaking. Knowing the details of water and product consumption allows the system to alert homeowners of a current leak, sub-optimal appliance usage or other weaknesses in best practices. Over time, data aggregation provides a history of usage and sound fingerprinting for increasing the accuracy and detail of the monitoring system. Furthermore, usage pattern analysis is useful for ongoing consumer education, understanding how consumers use products in everyday life, and automatic replenishment of consumable products based on actual usage estimates.

The sensors detailed herein are not complicated, and their low complexity reduces individual sensor cost and minimizes power consumption. In some embodiments, only a small amount of processing is done in each sensor as the task of dissecting each sound, matching the sound amplitude and spectral energy to typical or stored patterns, and implying consumption measurements occurs in a centralized processing computer. Sensors use their internal processors to control the duty cycle of the sensing activity, compact and store data, coordinate communications with other wireless nodes, and, in some embodiments perform Digital Signal Processor (DSP) functions on the sound signals to assure privacy and minimal data creation prior to sending the sensor information to the centralized processing computer.

Sensors may communicate wirelessly to other sensors for relaying data, or to wireless hubs, routers, and eventually through the Internet to remote processing facilities. In another embodiment, some sensors may use wired connections to aggregation assemblies that provide easier access to power supply sources (batteries or mains power), and improved wireless signal coverage from the location and larger radio power available at the aggregator location.

The sounds, vibrations, temperatures, and system analytic functions may be computed: in the cloud; by applications running on computer systems owned by service providers, manufacturers, vendors, or distributors of consumable products; applications running on mobile platforms or desktop computing devices; or by a combination of these systems. For convenience or immediate action, results, reports, alerts, and alarms may be returned to the consumer via an application running on a mobile device or a desktop computing device.

The output of the analytics function implies usage and consumption behaviors which may be compared to patterns from others or groups of others. Because sensors are located and tuned for monitoring utilization in specific locations or valve usage, detailed usage history is analyzed for metadata that increases the accuracy of the consumption estimates and usage patterns. Best, recommended, or preferred practices may be established for consumption behaviors and compared to past or current behavioral patterns. Programmable system policy and accumulated metadata are used determine the specific actions that result from the analytics and implied consumptions. In one example, users may be notified of ways to improve behaviors and conserve effectively, while packaged goods manufacturers may be provided with reports about how consumers are using their products. Consumers may be given suggestions for improving conservation, efficient use of products, or the need to call in experts for leaks, broken water heaters, or clogged drains. Estimates of product consumption are compiled and may be used to determine when replenishment is necessary. Replenishment can then be enabled through a click-to-replenish function on the consumer's device or through automatic replenishment based on consumption estimates, or through a combination of both.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 shows a block diagram of an ambient sound sensor, in accordance with an embodiment.

FIG. 2 shows a block diagram of a contact sound sensor, in accordance with an embodiment.)

FIG. 3 shows a block diagram of a temperature sensor, in accordance with an embodiment.

FIG. 4 shows a block diagram of an aggregator for connecting the sensors shown in FIGS. 1, 2, and 3, in accordance with various embodiments.

FIG. 5 shows a block diagram of three aggregated sensors coupled with an aggregator, in accordance with various embodiments.

FIG. 6 shows a block diagram of a tri-sensor assembly, in accordance with various embodiments.

FIG. 7 shows a block diagram of a tri-sensor assembly with an external radio and power supply, in accordance with various embodiments.

FIG. 8 shows a block diagram of a typical installation of a tri-sensor in a home, facility, or apartment, in accordance with various embodiments.

FIG. 9 shows the computing environment with data feeds from multiple locations and analysis stack for behavioral proxy and reporting, in accordance with various embodiments.

FIG. 10 shows a block diagram of tri-sensor functional blocks, in accordance with various embodiments.

FIG. 11 shows power saving and duty cycle control of a tri-sensor in accordance with various embodiments.

FIGS. 12A-12G show an example packaging option for the tri-sensor, in accordance with various embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Overview

Gathering information for consumable usage in homes or other facilities using sound and vibration is possible using individual sensors that attach under sinks, attach near appliances, attach near water pressure lines, attach to water pressure lines, attach near toilets, attach near drainpipes, or attach to drainpipes. The objective of any sensor described herein is to determine if water is being used, how much water is being used, if the water usage is hot water or cold water, if water is draining properly, or if a valve or drain stopper is not closing securely. Sensors may include sensitive microphones for including ambient sounds, such as the sounds of an appliance in distinct phases of the appliance cycle, sounds of toothbrushes or electric toothbrushes, sounds of electric or blade razors, shower sounds, bath sounds, sounds of toilet leaks, sounds of toilet parts functions, or sounds of toilet operations or of toilet paper spindle rotations. Correlation of ambient sounds with the direct sounds of plumbing pipes and drain lines is used for determining water conservation measures, correct appliance usage, or estimation of consumable product usage.

In some embodiments, each sensor operates independently and transmits its information to a central processing computer for pattern recognition and usage estimation. In one embodiment, the independent sensors may have their outputs combined in a nearby aggregator to reduce the number of wireless transmissions required and to share a common power supply. Each sensor assembly is designed with a small or limited amount of internal intelligence to keep manufacturing costs low and power requirements to a minimum. The ambient sound sensor assembly may include a DSP component allowing the processing of sounds prior to transmission. The DSP refines and selects the desired noises and sounds, hence reduces the number of sounds that need to be sent to the central processing computer. The secondary purpose of the DSP is assuring that voices or conversations are not intelligible or transmitted providing privacy and security for the user. Additional encryption may be included between the sensor assemblies and the central processor for enhanced privacy and security.

### Types of Sensors

There are several types of non-invasive sensors that are useful in detecting sounds and temperatures, some non-limiting examples include: a surface contact transducer, a submersible hydrophone, a submersible microphone, a directional ambient microphone, an omnidirectional ambient microphone, and thermal sensing devices. Such sensors may be designed in separate assemblies and packages or combined into a single assembly and package that includes two or more sensors, some of which may be the of the same type. In one embodiment, a single assembly and package combines the ability to detect contact sounds, ambient sounds, and temperature. This combination assembly is termed a “tri-sensor” and is a versatile configuration because it combines three useful sensor types into a combined “tri-sensor” assembly and allows higher volume manufacturing of this tri-sensor assembly type.

Another type of sensor is an invasive sensor that is inserted into the pressure water flow by replacing one of the flexible supply lines with a custom supply line that includes the sensor. The supply lines are the flexible coupling hoses between the wall valves and the faucets, valves, appliances, or toilets. These short supply lines are typically connected by compression fittings or threaded fittings on each end. Supply lines come in many materials such as copper, rubber, braided polymer, and stainless steel sheathed braided polymer. Because the threaded fittings on each end of the supply line vary by installation, adapters are included with the invasive sensor to accommodate most installations.

The benefits of the invasive sensor are many, which may offset the risk of installation difficulty and potential leaky installations requiring professional remedial or installation assistance. The benefits of the invasive sensor include all the positive benefits of the tri-sensor and add the following features:
A turbine generator that produces power when water is flowing. This locally generated power can be used to re-charge sensor batteries or power external devices such as toilet cleaning devices or under-sink lighting.
Pressure monitoring sensors that provide increased accuracy in measuring water flow by knowing the absolute pressure available at the valves and thus can provide a more accurate estimate of water consumption.
Water tap-off that may be used to feed external water quality analyzers, water chemical detectors, or fill auxiliary equipment such as automated toilet cleaners. The water tap-off is a flow-controlled, low-flow port that is gated by an electronic valve in the sensor assembly.

The invasive sensor runs the risk of needing to turn off supply line valves which may be old and begin to leak once the valve handle is turned, or old, corroded fittings may weaken and leak while attempting to replace the supply line with the specialized supply line containing the invasive sensor. Additionally, it is not practical to supply adapters for every fitting ever used on supply lines so it is possible that the installation kit might not contain the correct fitting adapter. Finally, the invasive sensor assembly, custom supply line, and adapter set costs considerably more to manufacture than the simpler non-invasive sensors or tri-sensor.

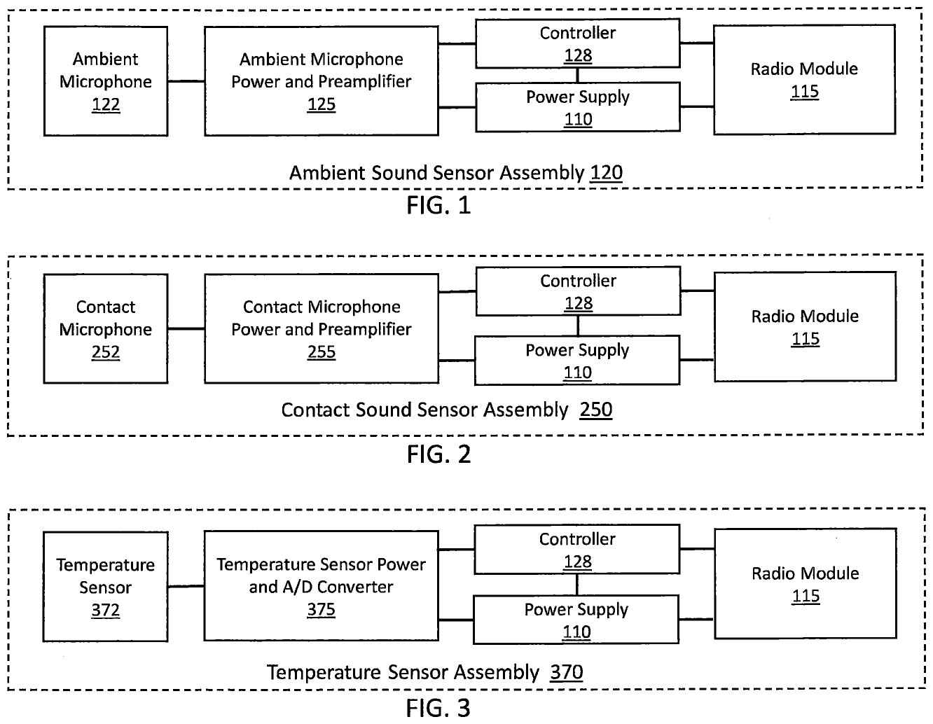

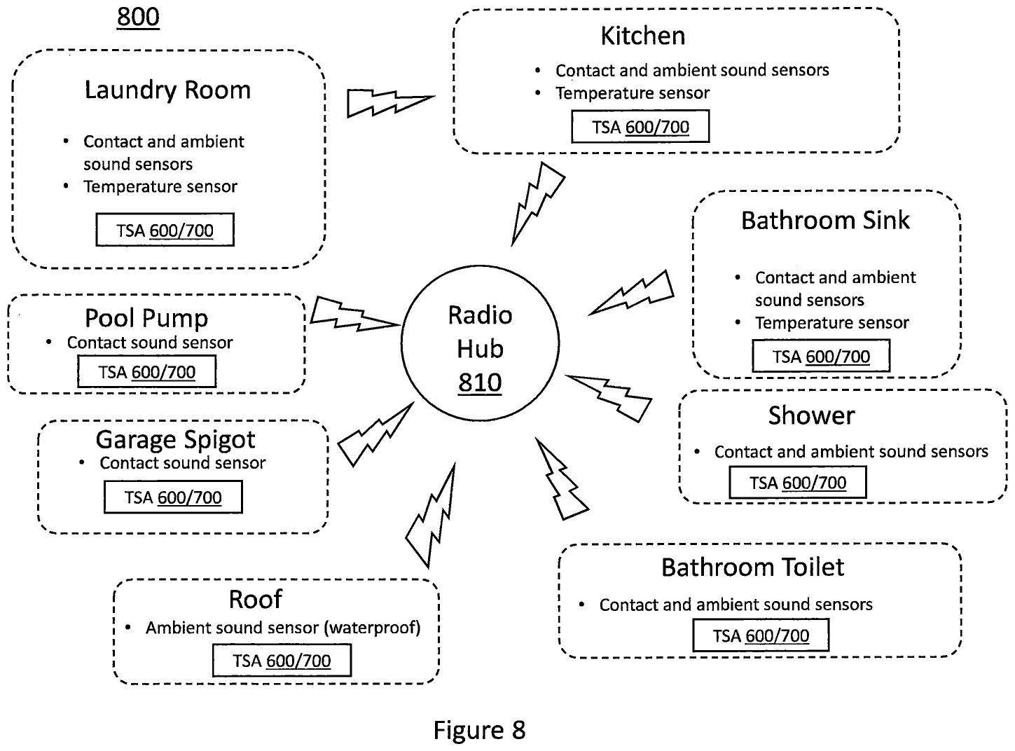

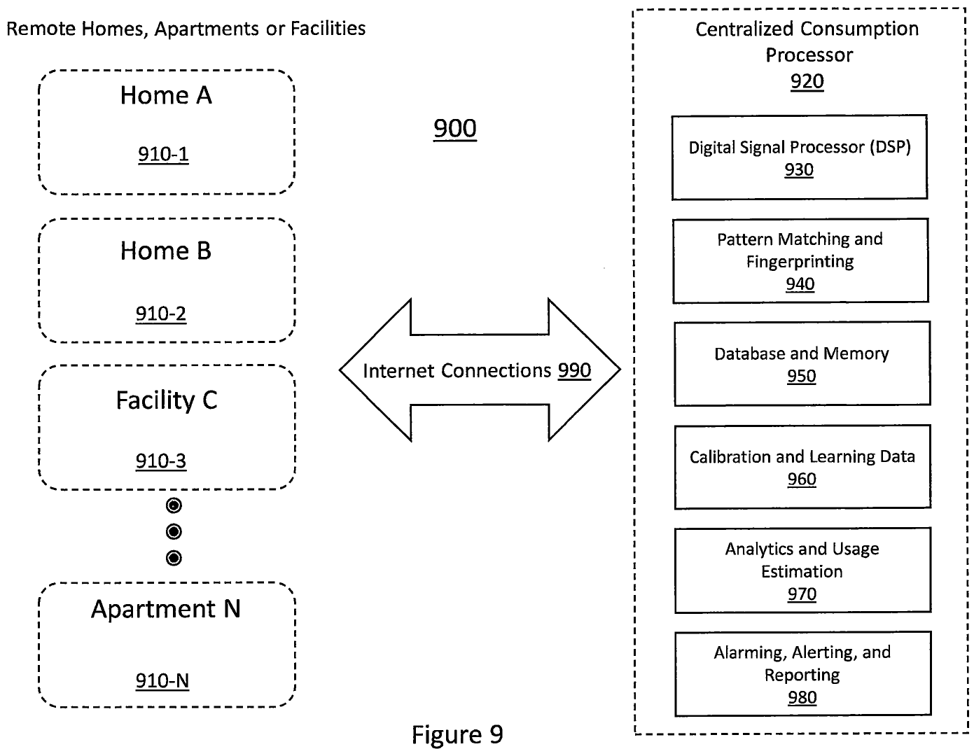

At the system level, the individual sensors detect sounds related to water or product consumption and forward that information to the central computer for analysis, implications, and actions. FIGS. 1-3 show block diagrams of sensor assemblies which include the three types of non-invasive utilization sensors: ambient sound, contact sound, and temperature. Each of the sensor types may be constructed as individual assemblies or they may be combined in a triple combination creating a tri-sensor assembly as shown in FIGS. 6 and 7. The invasive type sensor is not explicitly shown in the table because the specialized added functionality is not required in most of the installation locations.

Turning now to the figures, FIG. 1 shows a block diagram of an ambient sound sensor assembly 120, in accordance with an embodiment. The ambient microphone 122 may be a condenser microphone, piezoelectric, electret, dynamic, or micro-electro-mechanical systems (MEMS) type microphone. The contact microphone 122 may be used in conjunction with ultra-low-power circuitry in the Power and Preamplifier function 125 allowing sounds above a threshold level to trigger a wake-up signal to the Controller 128. Controller 128 may be any suitable microcontroller, microprocessor, field programmable gate array, application specific integrated circuit, or the like. In some embodiments, controller 128 may include a digital signal processor (DSP) either as hardware or as logic which performs DSP functions. The ability of the microphone 128 and preamplifier 125 functions to Wake on Sound (WoS) allows ultra-low power consumption while in the sleep state and assures that important sounds are not missed. The controller 128, once awake, then processes the incoming sounds from the Preamplifier 125, converts the analog sounds to a digital stream, compresses the data, and selects the portions of the data that need to be transmitted to the centralized computer system for further analysis. In some embodiments, the controller 128 contains an on-board DSP and may process the incoming sound stream using the DSP function to emphasize specific sound patterns related to consumption activities or may employ the DSP function to mask, distort, or eliminate sounds that would breach personal privacy such as conversations or other human sounds. The Radio Module 115 is a wireless communication assembly using commonly available technologies such as Bluetooth, BLE, Zigbee, or 802.11 WiFi. In one embodiment, the radio module 115 provides the ability to relay a signal from a remote sensor or communications hub from/to other sensors or hubs. In this embodiment, the controller 128 may provide a time synchronization function enabling the radio module to wake and repeat signals on a schedule established by the central computer system for use throughout the home or facility. The radio state, power, and duty cycle are controlled by the controller and DSP 128. The power supply 110 is a battery or other power source as shown in Table 1 and described in the adjoining paragraphs.

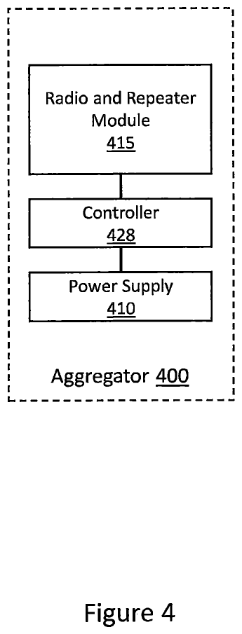

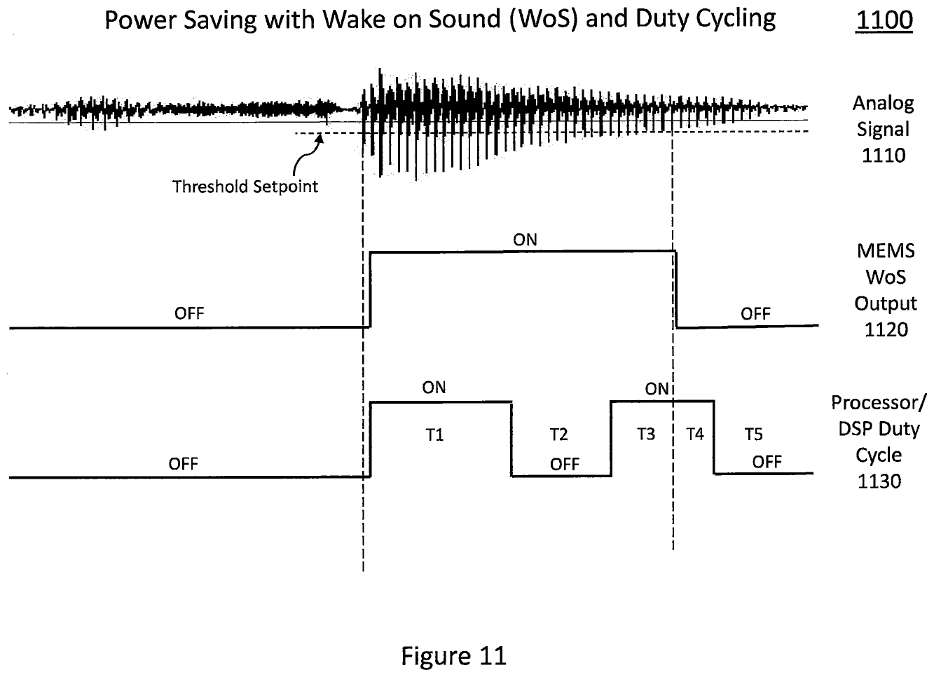

FIG. 2 shows a block diagram of a contact sound sensor assembly 250, in accordance with an embodiment. The contact microphone 252 may be an accelerometer, condenser microphone, piezoelectric, electret, dynamic, or micro-electro-mechanical systems (MEMS) type microphone. The contact microphone 252 is in direct contact with the water pressure feedline or the drainpipe. The contact microphone 252 may be used in conjunction with ultra-low-power circuitry in the power and preamplifier function 255 allowing sounds above a threshold level to trigger a wake-up signal to the controller 128. The ability of the contact microphone 252 and preamplifier 255 functions to Wake on Sound (WoS) or vibration allows ultra-low power consumption while in the sleep state and assures that important sounds are not missed. The controller 128, once awake, then processes the incoming sounds from the preamplifier 255, converts the analog sounds or vibrations to a digital stream, compresses the data, and selects the portions of the data that need to be transmitted to a centralized computer system for further analysis (as illustrated, for example, in FIG. 9). In one embodiment, sounds or vibrations are digitized and passed directly to radio module 115 for processing at the centralized computer system. In one embodiment, sounds or vibrations are digitized and used with minimal processing to simply trigger the controller 128 to signal the central computer system or a local device that a sound has been detected. In some embodiments, the controller 128 may incorporate an on-board DSP and process the incoming sound stream using the DSP function to emphasize specific sound patterns related to consumption activities or may employ the DSP function to mask, distort, or eliminate sounds that would breach personal privacy such as conversations or other human sounds. The radio module 115 is a wireless communication assembly using commonly available technologies such as Bluetooth, BLE, Zigbee, or 802.11 WiFi. The radio state, power, and duty cycle are controlled by the controller 128. In one embodiment, the radio module 115 provides the ability to relay a signal from a remote sensor or communications hub from/to other sensors or hubs. In this embodiment, the controller 128 may provide a time synchronization function enabling the radio module to wake and repeat signals on a schedule established by the central computer system for use throughout the home or facility. The power supply 110 is a battery or other power source as shown in Table 1 and described in the adjoining paragraphs.

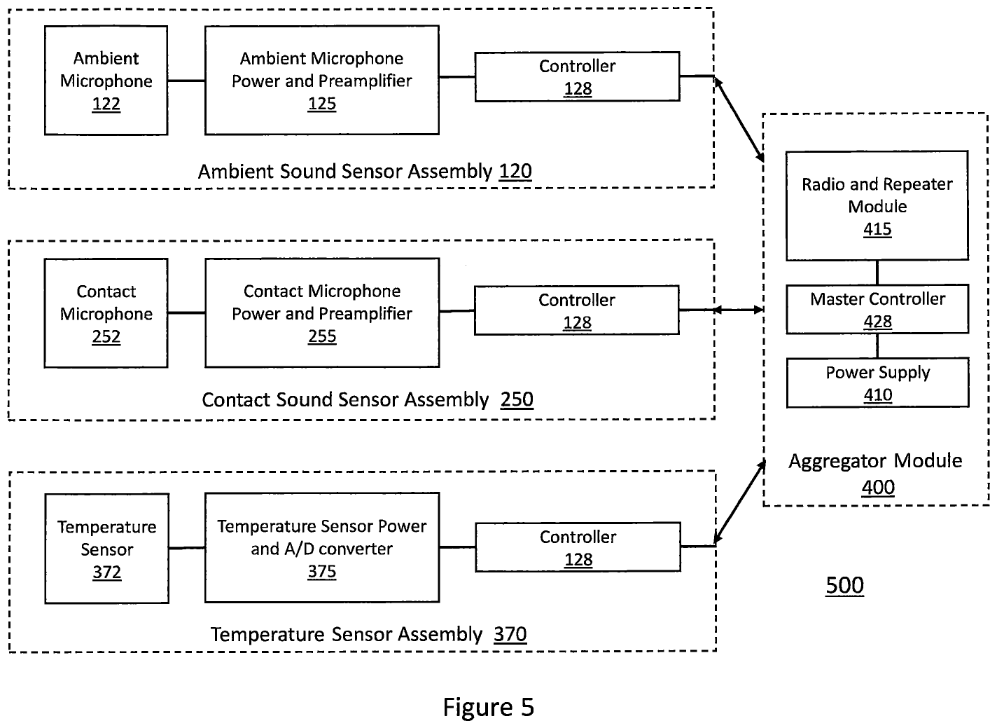

FIG. 3 shows a block diagram of a temperature sensor assembly 370, in accordance with an embodiment. The temperature sensor 372 may be a standard thermoelectric probe that is in direct contact with a water pressure feedline or a drainpipe and is used to measure the temperature of the water or drain water, however other suitable temperature sensors may be employed. The temperature sensor 372 is supported by the temperature sensor power and A/D converter 375 which provides an ultra-low-power source, and, in one embodiment, a Wake on Temperature (WoT) change or threshold trigger for the controller 128. In the case of a temperature sensor assembly only, the controller 128 may be a simple processor used to control the duty cycle of the sensor and the control the state, power, and transmit/receive or relay functions of the radio module 115. In one embodiment, the radio module 115 provides the ability to relay a signal from a remote sensor or communications hub from/to other sensors or hubs. In this embodiment, the controller 128 may provide a time synchronization function enabling the radio module to wake and repeat signals on a schedule established by the central computer system for use throughout the home or facility. The power supply 110 is a battery or other power source as shown in Table 1 and described in the adjoining paragraphs.

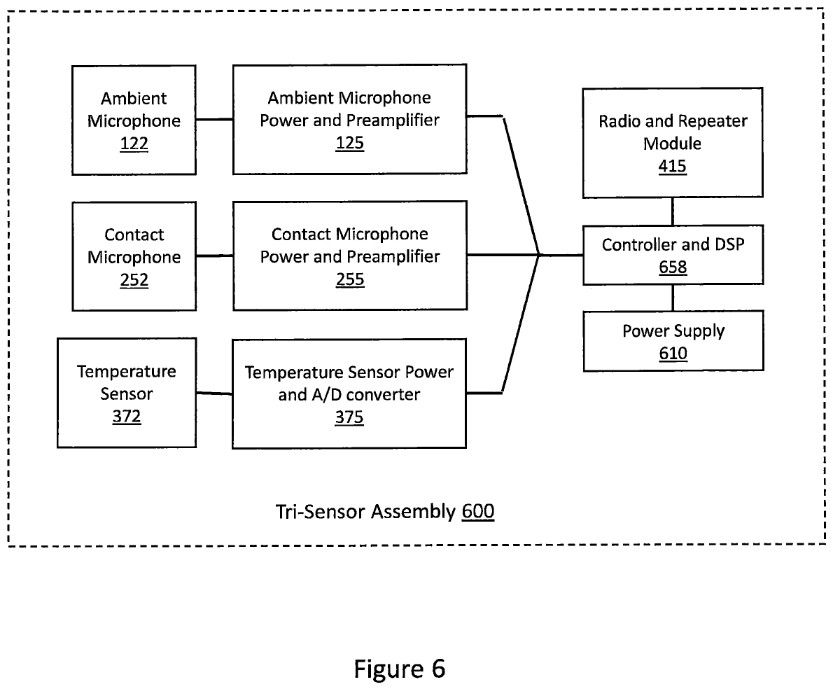

FIG. 4 shows a block diagram of an aggregator 400 for connecting the sensors shown in FIGS. 1, 2, and 3, in accordance with various embodiments. The aggregator module 400 may be used with one or more sensors attached via wires and sharing a common platform for the functions of radio, controller, and power supply. In this embodiment, the controller 128, the sower supply 110, and the radio module 115 shown in FIGS. 1, 2, and 3 are removed from the sensor assembly and supplied by the aggregator module 400. The aggregator module 400 may be located in a more convenient location than the sensors which are typically located near valves and in difficult-to-reach locations. Positioning the aggregator module 400 near the front of cabinets or up higher in more exposed locations may improve the radio signals and allow communications from areas where the sensor location is shielded or behind attenuating surfaces. Additionally, the aggregator module may contain a larger power supply 410 for longer life or to supply multiple sensors that share the power supply. The larger power supply 410 in the aggregator module 400 also allows the radio to operate with longer duty cycles or, if needed, continuously. The controller 428 within the aggregator module 400 is also a shared device which performs the functions described for the controller 128 for multiple sensors simultaneously.

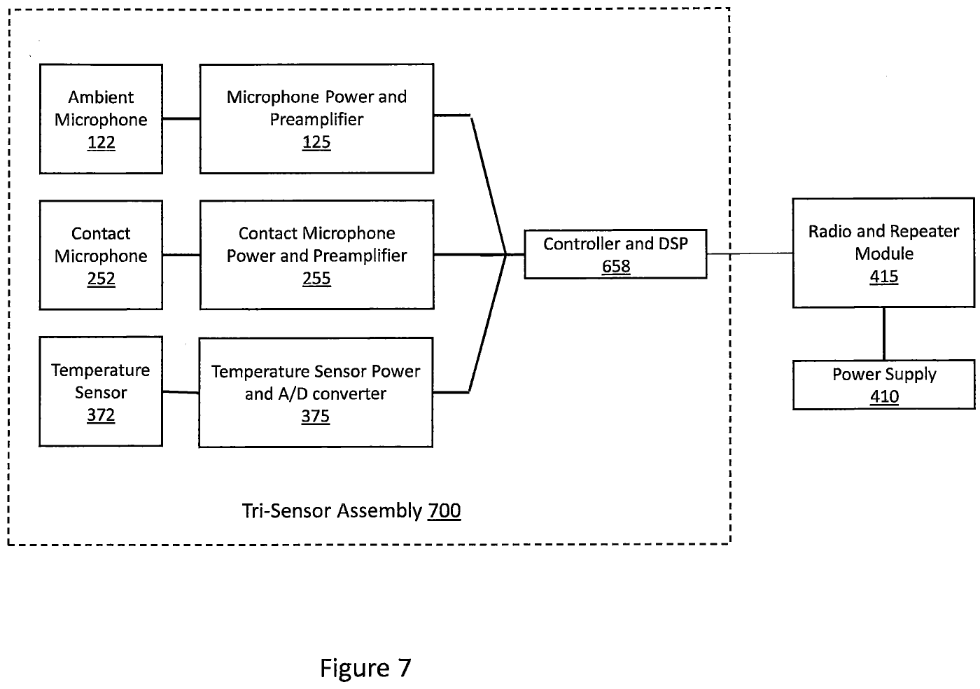

FIG. 5 shows a block diagram 500 of three aggregated sensors coupled with an aggregator module 400, in accordance with various embodiments. Various sensors can be linked to an aggregator module 400 to reduce the total cost for a system of sensors and improve the performance when multiple sensors are in or near the same physical location. In block diagram 500, three different types of sensors 120, 250, and 370 are aggregated in a single aggregator module 400. When using an aggregator module, the Controller 128 may not be required in each sensor assembly 120, 250, and 370. In some embodiments, the sensors may of the same type. For example, a set of sensors under a kitchen sink might be comprised of one contact sensor for the cold water line, one contact sensor for the hot water line, one temperature sensor for the hot water line, one contact sensor for the dishwasher feed line, one ambient sound sensor, and one sensor for the common drainpipe. The array of sensors would provide detailed consumption information and could all be combined, powered, and controlled with a single aggregator module 400. The aggregator 400 allows a master controller 428 to identify, process and combine the discrete signals from each of the connected sensors which share a common power supply 410 and radio and repeater module 415. Sensor are typically connected to the aggregator module using cable assemblies and plug-in connectors that carry power and signals between the devices. Although three sensors are shown coupled with aggregator module 400, a greater or lessor number may be coupled with an aggregated by aggregator module 400. For example, there may be two of the same or different types of sensor assemblies aggregated in some embodiments. In other embodiments, there may be more than three sensors, such as 5, 10, or 15 sensors coupled with aggregator module 400. For example, in one embodiment, two temperature sensor assemblies 370, three contact sound sensor assemblies 250, and two ambient sound sensor assemblies 120 are coupled with aggregator module 400.

FIG. 6 shows a block diagram of a tri-sensor assembly 600, in accordance with various embodiments. Addressing one of the more common sensor configurations, a single housing containing three complementary sensors provides a simple, inexpensive consumption sensor termed a “tri-sensor” assembly (TSA) 600. In one embodiment, the ambient, contact and temperature sensors are arranged in a single package such that the contact and temperature sensors are in tight contact with the pipe or valve being monitored, and the ambient sound sensor is acoustically isolated from the pipe and positioned to be maximally sensitive to surrounding sounds. The three sensor types share a single controller and DSP 658 which operates the radio and repeater module 415 and uses a common power supply 610. It is not necessary that all three sensor types are activated or used in a tri-sensor assembly such as shown in 600.

FIG. 7 shows a block diagram of a tri-sensor assembly 700 with an external radio/repeater 415 and power supply 410, in accordance with various embodiments. The benefit of separating a simplified tri-sensor assembly 700 from its associated radio and repeater module 415 and power supply 410 is that the assembly 700 can be installed deep within a cabinet or other hard-to-reach location while positioning the radio and repeater module 415 for improved signal quality and making the power supply 410 more easily available should a battery need charging or replacing. It is not necessary that all three sensor types are activated or used in a tri-sensor assembly such as shown in 700.

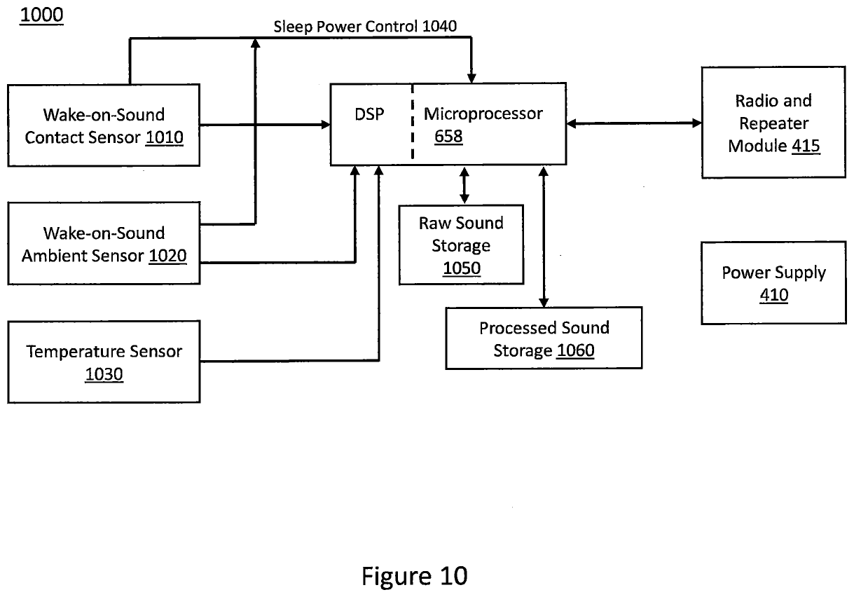

FIG. 8 shows a block diagram of a typical installation 800 of a plurality of tri-sensor assemblies (TSAs) 600/700 in a home, facility, or apartment, in accordance with various embodiments. In FIG. 8 various rooms, valves, faucets, spigots, appliances, or locations are shown where sensors may be attached to plumbing to monitor consumption or detect leakage. In one embodiment, tri-sensors (TSA 600/700) are used in each location with the primary sensor type indicated in the location box. Not all sensor types are necessary in all locations and either singular sensor types such as those shown in FIG. 1, 2 or 3 may be used, or a tri-sensor may be used with one or more sensors disabled by software control. The sensors may communicate directly with a radio hub 810 or may be configured to communicate via a relay or repeater function from an alternate nearby sensor. For example, FIG. 8 shows the laundry room using the repeater function of the kitchen to communicate with the radio hub 810 and ultimately connect through the Internet to the central computer system (see e.g., central consumption processor 920 in FIG. 9).

The radio systems used by the sensors, aggregators, and hubs are low-power systems using commercially available radio modules typically used in small mobile devices and IoT devices. Common wireless data transmission technologies used today include Bluetooth, Bluetooth low energy (BLE), Zigbee, Wifi (802.3), LTE, 5G, or other current or emerging RF technologies.

FIG. 9 shows the computing environment 900 with data feeds from multiple locations and analysis stack for consumption proxy, alarming, alerting, and reporting, in accordance with various embodiments. A central computer processing server supports multiple locations through data connections via a network or the Internet. In some embodiments, sensors and/or aggregators can store and forward data streams in a bursty data flow from each geographic location. For example, data from Home A 910-1, Home B 910-2, Facility C 910-3, apartment N 910-N, plus a plethora of other possible locations are routed to a centralized consumption processing system 920. System 920 performs two major functions: 1) databasing and compiling a wide set of metadata for sounds and vibrations useful for identification of appliances, toilets, and consumption information; and 2) detailing consumption information for each specific location and processing the specific data from each of those locations to generate information for the location or for product suppliers.

Data and sound information reaching the centralized consumption processing site 920 via a network or Internet connection 990 may be further processed by an advanced DSP function 930 which focuses on specific sound profiles and is capable of detecting consumption indicating sounds in the presence of other background noises. By using the growing database of metadata from multiple sites and the specific data created by multiple events at the specific site, the system extracts and matches sound or vibration patterns to prior known sound or consumption activities using a pattern matching and fingerprinting process 940.

The database and memory function 950 houses a library of processed sounds, vibrations, temperatures, locations, and calibration information that enable consumption estimations and activity identifications such as:
Identification of appliance type, manufacturer, model number, and location (washers, dryers, dishwashers, disposals, icemakers, water dispensers, etc.) without needing to identify the item during calibration or should the item be replaced after calibration;
Identifying the toilet brand, model number, gallons per flush data, fill valve maker, and location;
Identifying the pool or spa pump manufacturer, filter information, and possible replacement parts;
Identifying valve information for watering systems and outdoor faucets;
Identification of sounds and vibrations regarding consumable products, product sizes, and anticipated consumption;
Time-of-day, day-of-week, and seasonal consumption information
Sounds and behaviors of individuals used to anonymously identify consumers and consumer consumption estimates.

The database and memory function 950 is updated with initial or subsequent calibration and learning data functions 960 collected by requesting information from the user via a local app or by using historical data, metadata, and current sound/vibration information to “learn” improved estimates of consumption and product usage. The combination of database and memory 950, and calibration and learning data 960, enable the centralized consumption processor to derive increasingly accurate consumption information and usage estimation in the analytics and usage estimation function 970.

The alarming, alerting, and reporting function 980 uses computer policy to determine what actions to take based on information from the analytics and usage estimation function 970. The computer policy is determined by information gathered during the calibration process and dynamic information derived from metadata from a plethora of users, locations, and appliances. Policy may drive some the actions in the alarming, alerting, and reporting function 980 such as, but not limited to the “Actions” shown in Table 3. The reporting information generated in 980 may be used by the users of the sensor system or may be used by third party organizations or suppliers to determine product consumption, product usage characteristics, or remediations for leaky or faulty valves, washers, controllers, or appliances.

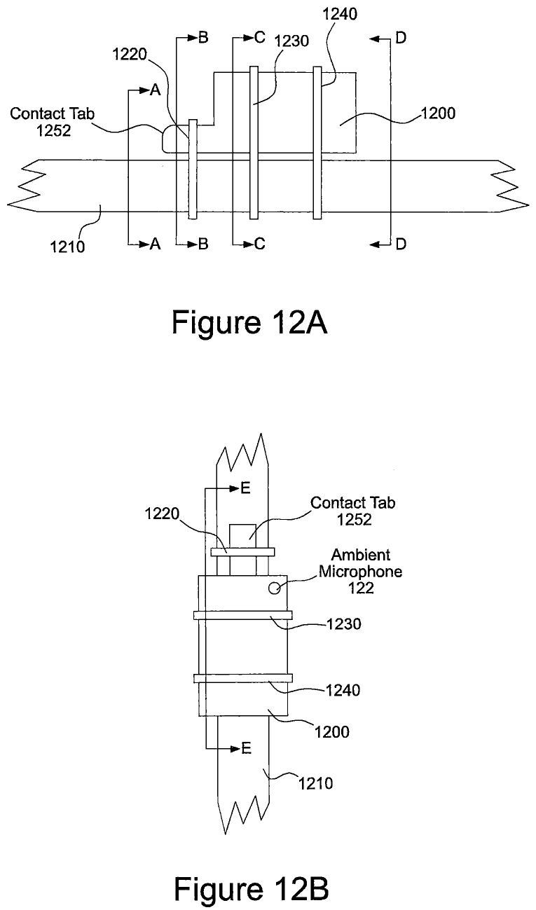

FIG. 10 shows a block diagram 1000 of tri-sensor 600/700 functional blocks, in accordance with various embodiments. In one embodiment, the tri-sensor may be an ultra-low-power monitoring device with a battery life exceeding five to ten years. The benefit of long battery life is: 1) sensors are sometimes located on or adjacent to valves in difficult to reach locations or behind finished surfaces such as drywall, hence the battery would be difficult to replace or charge; and 2) once the sensor is placed into service, calibrated and accumulating usage metadata, any movement or displacement of the sensor as attached to the pipe could change the sound/vibration characteristics and require re-calibration or relearning historical information.

The contact sensor 1010 and the ambient sound sensor 1020 may employ WoS technology to reduce power consumption to less than a few microamps until a sound or vibration is detected. Once a sound is detected one or both WoS sensors may send a sleep power control signal 1040 to the microprocessor to wake the processor and begin to process the sounds or vibrations. For example, an ambient sound sensor near a valve under the bathroom sink may wake based on sounds from a person making noises in the bathroom that exceed the minimal threshold of the WoS device. Once the processor wakes and begins processing sounds, vibrations, and temperatures 1030 from other sensors, it may detect the quieter sounds of a nearby shower being operated. In this example, the shower valves are not directly monitored by sensors and the vibrations created by operating the shower faucets are below the threshold for a WoS detection from the under-sink location, yet because ambient sounds triggered the tri-sensor to briefly “listen” to all sensors, it was able to detect the more distant sound and process the sound as a shower in operation. The DSP and microprocessor 658 caches both raw sounds/vibrations 1050 and DSP processed sounds/vibrations 1060 for transmission to the centralized consumption processor which then may derive patterns implying activities and creating actions.

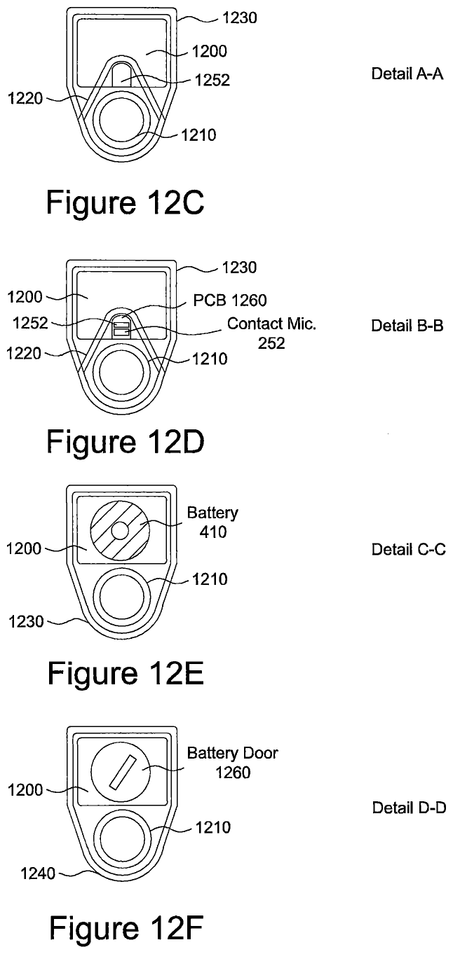

FIG. 11 shows a power saving and duty cycle control timing diagram 1100 of a tri-sensor assembly 600/700 in accordance with various embodiments. Wake on Sound is key to saving power and extending battery life of each sensor assembly. The ambient sound sensor and the contact sound sensor may each have a WoS function and a corresponding sound threshold based on the analog sound signal 1110 that triggers the wake-up output line 1120 to the microprocessor. In order to further reducing power consumption a duty cycle 1130 is overlayed so that even if the WoS output is positive, the microprocessor is cycled such that sound/vibrations are periodically sampled and not continuously streamed. Computer policy is used in conjunction with the detected and fingerprinted sounds to determine the duty cycle timing for the initial “on” time T1, the duty cycle “off” time T2, subsequent “on” times T3, and hysteresis “on” hold time T4. The final “off” time T5 may be modified by policy to activate the processor periodically even though WoS output 1120 is not triggered.

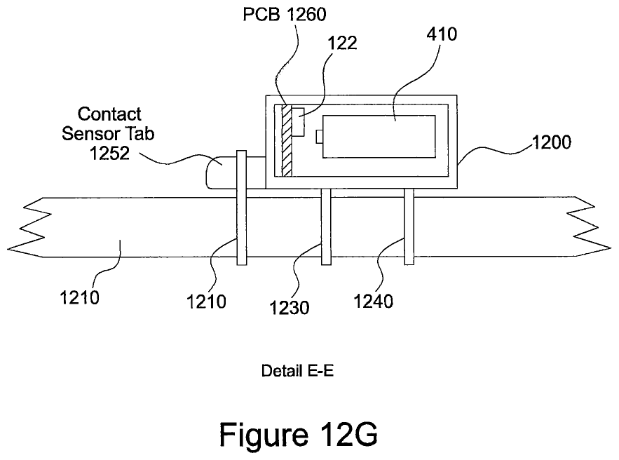

FIGS. 12A-12G show an example packaging option 1200 for the tri-sensor assembly 600/700 in an example coupling with a pipe 1210, in accordance with various embodiments.

FIG. 12A is a side elevational view an example packaging option 1200 for the tri-sensor assembly 600/700 in an example coupling with a pipe 1200, in accordance with various embodiments. As illustrated in FIG. 12A, in some embodiments, a tri-sensor assembly 600/700 may be removably mechanically coupled or permanently mechanically coupled to a pipe 1210 by any suitable means. In the illustrated embodiment, cable ties (e.g., 1220, 1230, and 1240) are used to facilitate a removable mechanical coupling of the packaging 1200 of tri-sensor assembly 600/700 to a pipe 1210. FIG. 12A also shows markings for several detail views, including: Detail A-A; Detail B-B; Detail C-C; and Detail D-D. In one embodiment as illustrated in FIG. 12A, there is small tab 1252 containing the contact sensor 252 and temperature probe 372. The small tab 1252 allows tightly securing the tab portion 1252 of the housing 1200 to the pressure line, valve or drainpipe being monitored. The small tab 1252 is secured separately with a strap, cable tie, or other securing method forcing the contact sound/vibration/temperature probe (252/372), contained in tab 1252 to be in close contact with pipes 1210 with diameters greater than or equal to one-quarter inch. Herein, the small tab 1252 may also be referred to as the “contact tab.”

FIG. 12B shows a top plan view of the example packaging option 1200 for the tri-sensor assembly 600/700 in an example coupling with a pipe 1210, in accordance with various embodiments. In the embodiment illustrated, the ambient sound sensor microphone 122 is shown facing away from the monitored pipe and on the opposite side of the housing 1200. FIG. 12B also shows markings for detail view E-E shown in FIG. 12G.

FIG. 12C shows a detail view A-A of the example packaging option 1200 for the tri-sensor assembly 600/700 in an example coupling with a pipe 1210, in accordance with various embodiments. The figure illustrates one method of securing the contact tab 1252 to the pipe or feedline being monitored 1210 using a strap or cable tie 1220.

FIG. 12D shows a detail view B-B of the example packaging option 1200 for the tri-sensor assembly 600/700 in an example coupling with a pipe 1210, in accordance with various embodiments. In this example illustration, the cutaway exposes the printed circuit board (PCB) 1260 which includes a contact sensor and a temperature sensor probe 372 (not visible) facing the pipe being monitored 1210.

FIG. 12E shows a detail view C-C of the example packaging option 1200 for the tri-sensor assembly 600/700 in an example coupling with a pipe 1210, in accordance with various embodiments. In this example illustration, the cutaway exposes a cylindrical battery 410 which is isolated from temperature changes in the pipe, feedline or valve being monitored 1210.

FIG. 12F shows a detail view D-D of the example packaging option 1200 for the tri-sensor assembly 600/700 in an example coupling with a pipe 1210, in accordance with various embodiments. In this example illustration, the view from the opposite end shows a battery door 1260 which also functions as a power switch for the sensor.

FIG. 12G shows a detail view E-E of the example packaging option 1200 for the tri-sensor assembly 600/700 in an example coupling with a pipe 1210, in accordance with various embodiments. In this example illustration, the cutaway exposes a cylindrical battery 410 along with the PCB 1260 which contains, among other components, the DSP, microprocessor, radio module with antenna, and ambient sound microphone 122. The ambient sound microphone is acoustically isolated as much as possible from the sounds and vibrations which may be present in the pipe, feedline or drainpipe 1210 being monitored by the contact sensor and temperature sensor in the contact tab 1252

### Power System Options

Powering these small, remote sensors is achieved by one or more of several means as shown in Table 1. Battery technology continues to evolve, and the simplest solution is to use a semi-permanent long-life battery as shown in the first method in the table.

TABLE 1
Power Systems

| Method | Advantages | Disadvantages |
|---|---|---|
| Long-life battery. Replace in | Once-and-done installation. | Higher initial cost for battery, |
| 3-10 years. | Replacement only needed at | useful life may be <5 years. |
| | distant intervals. Secure | Replacement may be difficult |
| | mounting possible. | for average owner. |
| | | Replacement may change the |
| | | orientation of the sensor and |
| | | create new data patterns. |
| Rechargeable battery | Low cost. Does not require | Difficult to reach locations |
| | replacement. | limits charging methods. |
| | | Battery needs to be |
| | | removable to recharge. |
| | | Difficult to reach. |
| Photon charging | Wireless charging. Separate | Cabinet clutter may block IR |
| | IR transmitter is easy to reach | energy from emitter. |
| | and recharge. | |
| Thermal charging | Once-and-done installation. | Slow charging on occasional |
| | No need to touch sensor | basis. May fully discharge if |
| | again. | hot water is run frequently. |
| Separate infrared LED | Provides continuous power | Added cost and complexity. |
| charging module | from an easy-to-reach | Could be useful where |
| | module. | continuous monitoring is |
| | | preferred. |
| Separate battery pack wired | Sensor can be securely | Fragile wire. Wire length |
| to Sensor | mounted and need not be | could vary by location. |
| | touched again. Battery pack | Extension wires could be |
| | may be in convenient location | unreliable. Added costs. |
| | in cabinet or other location | |
| | near the valve or sound | |
| | source. | |

### Sensor Placement and Installation Locations

Sensors are typically placed under sinks, behind washing machines, near dishwasher lines, on rooftop vent pipes, or in other locations near valves or faucets. The sensors are oriented so that the battery compartment is most easily accessible and so that the ambient sound microphone is focused towards the most common sources of user or appliance sounds. Sensors should be located as close to valves or faucets as possible. Once each sensor is installed, calibrated, and data accumulation has begun, any movement, dislocation, removal, or replacement may disrupt sensor accuracy or require re-calibration.

### Sensor Mounting

The entire sensor assembly is secured to the pipe in such a way that it does not easily move or rotate on the pipe. Placement of the sensor is generally as close to the valve(s) as possible in order to be more sensitive to the sounds of the valve action and sounds of the water turbulence flowing through a partially or fully opened valve. In one embodiment, the sensor assembly is fastened to the pipe using standard, commercially available, cable ties that fit into narrow channels molded into the sensor assembly housing. The cable ties are snugly attached around the pipe and the sensor assembly assuring solid contact. In an alternate embodiment, the sensor assembly clips onto the pipe with a spring-loaded, curved clip.

Table 2 lists several ways to mount the sensor assembly and includes the advantages and disadvantages of each mounting method.

TABLE 2
Sensor Mounting Methods

| Mounting Method | Advantages | Disadvantages |
|---|---|---|
| Clip-on to Pipe | Frictionless user installation. | Different pipe diameters may |
| | Easy to relocate sensor. | require adapters. Not tightly |
| | Looks good in marketing | secured to contact surface. |
| | materials. | |
| Cable tie to pipe | Tightly secures to contact | Requires attention to install. |
| | surfaces. Easily adapted to | May require plyers or |
| | range of pipe diameters. | clippers for ‘professional |
| | Inexpensive and easy to | looking’ installation. |
| | replace. Replacement cable | Requires clippers to remove. |
| | ties available at local stores. | Additional cable ties needed |
| | | to re-locate sensor. |
| | | Additional SKU. |
| Stainless Steel Cable Clamp | Most secure to contact | Expensive. Some technical |
| | surfaces. Easily adapted to | experience needed. Risk of |
| | range of pipe diameters. Can | damage to brittle pipes. |
| | be relocated. | |
| In-line Sensor with Turbine | Powered by water flow plus | Requires replacing a water |
| Power | additional information from | feed line which may cause an |
| | being directly in the water | untrained user to create a |
| | stream. | leak. |

### Tri-Sensor Package Design

In some embodiments, the tri-sensor package 1200 (or the like) is designed for mounting to pipes or valves with diameters from approximately one-quarter inch to two inches or more. These pipes, valves, faucets, spigots, feedlines, vent pipes, or drainpipes maybe constructed from metals or plastics and may be rigid or flexible.

In one embodiment, FIGS. 12A-12G shows the tri-sensor package 1200 design with a small contact tab 1252 containing the MEMS contact sound sensor and a temperature probe. The contact tab 1252 is tightly secured directly to the pipe or drainpipe being monitored while the body of the tri-sensor package 1200 is held in place along the pipe with additional support bands. The support bands can be standard cable ties, stainless steel clamps, Velcro bands or other securing ties. The body of the sensor package 1200 may contain a circuit board which includes one or more of a MEMS contact sensor, an ambient sound microphone, a microprocessor with integrated DSP function, and a radio plus antenna for communicating wirelessly with a radio hub/central computer.

In one embodiment, the design includes a “V” notch in the sensor package 1200 for placing over the selected pipe and two standard nylon cable ties for tightly securing the sensor to the pipe. The vertex of the “V” notch contains a protruding contact sensor assembly that makes direct contact with the pipe. This contact sensor contains a MEMS microphone or a piezoelectric transducer element plus a thermoelectric probe for temperate measurement. Alternatively, the “V” notch may include an adjustable slide for the contact sensor and temperature probe to be positioned with best possible contact to the pipe. The sides of the “V” notch are covered with a non-slip coating or material which prevents the assembly from rotating or sliding out of position. The “V” notch allows attachment to pressure or drainpipes with diameters between ¼ inch and two inches.

In one embodiment, the sensor packaging 1200 shown in FIG. 12A-12E may include a small “V” notch to securely align the sensor assembly in the packaging 1200 with the pipe. In one embodiment, a contact sensor tab may be incorporated into the main housing eliminating the protruding tab 1252 and placing the contact sound sensor directly against the pipe along with the main housing.

In one embodiment, the tri-sensor assembly's packaging 1200 is affixed to the pipe with standard cable ties or Velcro straps. Alternatively, stainless steel pipe clamps may be used or other types of securing bands.

The contact sensor, within the packaging 1200, is held tightly against the pipe while a separate ambient microphone is acoustically isolated (by the packaging 1200) from the pipe and directs its sensitive region away from the pipe. This arrangement allows the tri-sensor to independently detect and process two different sound sources simultaneously.

The tri-sensor assembly 600/700 housed by packaging 1200 may be powered by a removable long-life battery. The battery cap is rotated ¼-turn as a power switch and ½-turn to open the cap and remove the battery. In some installations, the battery may be replaced without removing or re-orienting the sensor packaging 1200.

### Ultra-Low Power Consumption Sensor Operation

The nominal mode for each sensor is the deep-sleep mode. In this mode the microprocessor is in a deep sleep configuration and all but a single a MEMS sensor is used with Wake-on-Sound (WoS) functionality frequently found on IoT devices. This deep-sleep technique with wake-on-sound detection holds stand-by current draw to less than nominally 10 μA for the contact sensor while the remaining devices are turned off or in a sleep condition. Complementing the wake-on-sound function is a programmable duty cycle wake-on-cue for validating sensor assembly operation and detecting potential long-duration leaky valves or other water movement noises in pipes or drainpipes.

Typically, sound from actuating a nearby valve or closing/opening a drain stopper near the monitored pipe wakes the single MEMS sensor which then wakes the remaining sensor assembly including the microprocessor, the DSP, a MEMS ambient microphone, and a temperature sensor. The microprocessor then controls the sensor assembly and directs the collection of contact sounds, ambient sounds, and temperature. All sounds received by the contact and ambient MEMS sound sensors are then processed by the DSP according to the criteria established for the type of sensor, the placement of the sensor, the location of the sensor, the calibration information of the sensor, historical information regarding the sensor, and computer programming for the criteria of the sensor.

### Sensor Synchronization

Sensors can also function as repeaters for the low-power radio frequency (RF) signals to get from the local sensor to the radio hub or router that connects the premise to the Internet, hence creating communication between the local sensor and the cloud or remote central computer. The low power consumption requirement of each sensor dictates that duty cycles may be minimized, and each sensor can synchronize a wakeup with the potential of receiving a signal from a remote sensor that needs to be relayed towards the Internet. When a new sensor is installed, it attempts to reach the Internet via a direct connection to the radio hub or router. If a connection cannot be established, the new sensor goes into a “beaconing” mode where it attempts to connect to a previously installed, nearby sensor.

The UI on the mobile device is used to determine if the new sensor has achieved an Internet connection directly. If the new sensor does not achieve a direct connection, the other sensors are instructed by the central computer to shift into a high duty cycle wake-and-listen process where they listen for the beacon from the new sensor. The new sensor beacons with a random backoff, high duty cycle and the previously installed sensors “listen” with a high duty cycle, random backoff. Shortly, the new sensor will connect with an existing sensor and establish communication to the central computer. In one embodiment, the central computer may command all the previously installed sensors to receive continuously until the new sensor is detected. Once detected by one or more previously installed sensors, the signal strength of the connection is evaluated by the central computer and the previously installed sensor with the strongest signal is designated as the repeater sensor. In one embodiment, the UI on the mobile device queries the user for the name of the closest one or two sensors and only those sensors are placed into continuous listen mode.

If a relay sensor is required and once it is identified and connected, the synchronization process begins. In one embodiment, the new sensor receives a signal from the repeater sensor indicating the timing for the periodic duty cycle active time and duration. The sensors coordinate time and set internal clocks in synchrony with the clocks for the other sensors in the facility. In one embodiment, the central computer establishes a time synchronization signal for setting the internal clocks to the approximate time and then the sensors coordinate time synchronization within the facility. The central computer uses information regarding each sensor's function and relay status to determine the minimum acceptable duty cycle of each sensor thus preserving battery life while assuring consumption information is being recognized.

Each sensor has sufficient buffer memory to store sounds processed by the local DSP regarding water usage and product consumption. Once synchronized with the relay sensors, the remote sensor can deliver the stored, processed sounds via the relay sensor to the central computer. If the remote sensor is continuing to receive and process incoming sounds, it uses the communication protocol to keep the relay sensor active while it transfers the information to the central computer. The sensors use the communication protocol to determine if they should continue to stream data through the network or if they should return to the synchronized duty cycle to conserve battery life.

It should be appreciated that the IoT market includes commercial supplies of ultra-low power combination DSP, radio, and microprocessor integrated circuits such as the Icyflex design which may draw as little as 0.3 mA while running both the processor and the DSP. By way of example, and not of limitation, such circuit combinations may be employed in some of the sensor assemblies described herein.

### Calibration

Once the sensor is properly mounted on the pressure or drainpipe, and the power is activated, the sensor begins to detect, analyze, and communicate sounds and temperature information. Calibration can take place at any time thereafter as determined by the computer policy and information input by the user. Calibration requires a mobile device or local computer terminal that in communication with the central computer system, typically through the Internet. The central computer system, in some embodiments, is configured to register the local sensor once it is powered on and communicating with the central computer system. The user interface (UI) for the local computer or mobile device guides the user through a combination of questions and requested actions to gather relevant sounds, temperatures, and behaviors.

Once the sensor is registered, the central computer system makes the sensor status and calibration routine available to the user's mobile device or local computer so that the user can run the calibration routine at their convenience. The calibration routine is a programmed algorithm tailored by the computer policy that intakes the specific location of the sensor and then automatically selects the pre-programmed calibration algorithm. The function of the sensor is gathered during the calibration process through questions answered by the user and by user actions. Typically, the algorithm instructs the user to manipulate the valves, spigots, faucets, drains, appliances, or create other sounds indicative of water or product consumption.

For example, if the location is indicated as being a bathroom sink, the algorithm would have the user run through various valve positions for both hot and cold water, opening and closing the drain, filling the sink, making splashing sounds in the sink, and draining the sink. If the user indicates that there is a shower or bathtub near the sink, the algorithm may ask the user to actuate the same types of valve manipulations and related sounds of a nearby valve or faucet. The algorithm determines in near-real-time if distant valves, water flows, or sounds are detectable and useful, so that calibration can be truncated or extended based on the sounds being detected from more distant fixtures, appliances, toilets, or faucets.

The calibration routine includes asking the user about the surroundings, fixtures, toilets, and appliances. Fixtures may refer to water faucets, items attached to water lines, and/or items which have water faucets, such as sinks, tubs, and showers. Toilets refer to actual toilets and their like (e.g., bidets). While appliances refer to water using appliances such as ice makers, refrigerators (with ice and/or water dispensing functions), and washing machines. Information gathered may include one or some combination of the following information and/or other information:
Appliance type, manufacturer, model number, and location (washers, dryers, dishwashers, disposals, icemakers, water dispensers, etc.);
Toilet brand, model number, gallons per flush data, fill valve maker, and location;
Pool or spa manufacturer, size (gallons), filter information, chemical type, and location
Number of people living in the home;
Number of people using the pool or spa;
Number of bathrooms (toilets, bathtubs, showers, sinks);
Number of people typically using each bathroom;
Information for watering systems and outdoor faucets;
Information regarding consumable products, product types, product preferences, product sizes, and anticipated consumption;
Photographs of appliances, toilets, toilet valves, faucets, sinks, pool pumps, spas, room layouts, and sensor locations.

During calibration routines the policy determines the number and extent of questions asked and the actions requested of the user.

The calibration data is used as a starting point for the centralized analytics to understand the implications of the sensor data and begin to accumulate usage and consumption statistics. In one embodiment, the calibration routine for a toilet-located sensor may ask for specific model information and photographs of specific parts of the toilet. This information is then stored to provide details for identification of future replacement parts, consumption information, and leak pattern detection. Creating a database of model information, photographs and sounds will allow improved matching of partial data, such as sounds only, to a specific model number and related replacement part and consumption estimations.

Over time, meta-analysis of a series of sensor data, routine usage, and occasional information requests sent to the user through notifications to the mobile device improve the initial calibration.

### Primary Data

Primary data is the information that is transmitted from the sensor to the central computer for processing. If the sensor contains a DSP, some of the primary sounds may be already pre-processed to condense the data for reducing transmission times and to assure that human conversations are not included for personal security reasons. The primary data consists of specific sounds and sound clips that represent water flows, valve actions, and related surrounding ambient sounds. Temperature sensor data is included in the primary data.

In one example, the sound of a bathroom sink faucet opening (contact sound) is shortly followed by the sound of the sink drain being closed (ambient sound), followed by the sound of water collecting in the sink (ambient sound), followed by occasional splashing sounds (ambient sound), and lasting for about three minutes before the sink is drained (ambient and/or contact sound), likely indicates that someone is shaving at the bathroom sink. Additional information from the temperature sensor indicates that the sink drain was closed once the water warmed up, increasing the likelihood of the current set of actions representing the action of someone shaving.

In this example, the primary data may include one or more of the following primary data items: location of sensor; activity start datestamp; faucet opening; faucet flow sound; delay time before drain closing; water flow time before sink drain is closed; cold water run time; warm/hot water run time; the sound of water filling the sink; the dwell time while the sink is being filled; splashing sounds in the sink; delay time before opening the sink drain; activity end datestamp; incrementing a use case for a consumable (e.g., toilet paper, razor blade, shaving cream, toothpaste, tooth brush, electric toothbrush head, hand soap).

### Metadata

Primary data is accumulated, categorized, and stored, allowing the generation of metadata for refining the accuracy of utilization estimates and activity identification. The computer algorithm attempts to correlate incoming sounds with existing calibration information and historical saved information for determining utilization quantities and user identification. The calibration data provides a foundation for matching new sounds to the known sounds for the activities demonstrated during the calibration routine. This matching of sounds creates a statistical pattern that is used for fingerprinting each activity at each valve or faucet. The fingerprint is refined with subsequent matchings of incoming sounds.

Because a centralized processor is receiving sounds and indications from a plethora of sensors and sites across wide geographies, user demographics, and consumption habits, the increasingly large database of historical information can be mined to more accurately estimate consumption data, or evidence of specific leaks, or identification of appliance or valve types and manufacturers. The metadata collected helps refine consumption estimates and allow the system to identify specific components or consumable products in the user's environment without need for inquiry using the user interface.

For example, a large sample size of toilet fill valve types identified in the initial calibration questionnaire can be matched to the sounds detected in a large array of locations so the sound of the toilet filler valve alone is sufficient to identify the manufacturer and part number. As the database increases in size, many appliances, consumable products, and activities may become identifiable based on sound profiles alone.

Implying Consumption from Analyzed Data

The centralized analytics function may then interface with an application on a mobile device, tablet, or an application on a remote computing system for providing notifications, recommendations, alerts, or alarms to the consumers. In addition, the analytics indicate how effectively some products are used and estimations of how much of the product is consumed.

### User Interface

The centralized analytics function may then interface with an application on a mobile device or an application on a remote computing system for providing notifications, recommendations, or alerts to the consumers. The user interface (UI) provides the user with an intuitive way to perform calibrations, re-calibrations, visualize consumption information, order consumable products, and receive notifications, alarms, or alerts. The centralized processor may utilize multiple user interfaces each designed for a specific user. For example, the home user may interact with the system for seeing reports of consumption, getting information on product consumption and replenishment offers, and receiving alarms for excessive consumption or leaks. The user interface may also be designed for owners of rental properties who are more interested in excessive consumption activities and maintenance information. In addition, suppliers/vendors and manufacturers may be more interested in how products are being consumed and if manufacturer recommendations are being followed.

### Communication System

The remote sensors require a connection to a central computer system to report the data and sounds collected near each valve or faucet. Because the sensors are designed to be ultra-low power devices, they use low power communications such as Bluetooth, BLE, Zigbee, 802.11 (WiFi) or other low-power wireless communications typically used in IoT devices. The sensors then communicate to other network devices such as repeaters, hubs, routers, switches, or to other sensors for a relay of the signal. Ultimately, each sensor achieves bi-directional communication with the central computer system. Sensors typically provide occasional bursts of transmissions as they control their duty cycle to minimize power consumption while assuring that relevant information is sent to the central computer system.

### Illustrative Examples of Monitoring and Reporting

Table 3 provides examples for some of the possible monitoring situations, the implications from the analytics, and the possible actions based on the programmable policy. The following columns are shown in Table 3: Location, Sensor Type, Sensor Output, Implied Condition, and Action.

Location—indicates the area or valves surveilled by a sensor and provides a general location of a sensor. Sensors may be in or near the location specified or may be in an adjacent space that allows monitoring of the valves and plumbing in location shown.

Sensor Type—indicated one or more sensor types that would be optimal in monitoring the location specified. Not all sensor types listed for any location are required; however, having the full set of sensor types provides the most accurate and complete data for analysis. Note that invasive sensor is not explicitly differentiated.

Sensor Output—indicates the general sounds, vibrations or temperature fluctuations that are analyzed to determine the conditions in process at a given location. Digital signal processing is used to dissect the audible and vibrational sounds and match spectrally processed patterns to libraries of patterns or to calibration data. The Sensor Output column therefore represents the primary condition being detected at any location.

Implied Condition—indicates the human behaviors or the plumbing conditions that are likely to match the sensor output patterns. Stored patterns and behaviors are used as a proxy to imply what is likely to be happening at a location. Additionally, stored patterns are also used as a proxy to measure consumption of products and resources.

Action—indicates example actions the system may take given the implied condition. Actions are based on programmable policy that is provided by the system or modified by the user to produce the desired actions for each location and implied condition.

TABLE 3
Examples of Data Gathered, Analyzed and Reported from Pressure Lines

| | | | Implied | |
|---|---|---|---|---|
| Location | Sensor | Sensor Output | Condition | Action |
| May be | Type | Shows the output | Shows output | Uses the output and |
| close to the | One or more | after analysis and | after further | implied condition to |
| actual | types may be | comparison to | analysis and | push or archive data |
| location | implemented | calibration actions | pattern matching | based on policy |
| Bathroom | Ambient, | Contact sensor | Someone is | Notify user (or parent) |
| Sink | Contact, | indicates water | brushing their | that water is being |
| | Temperature | running slowly, | teeth using hot | wasted and energy is |
| | | ambient sensor | water and letting | being wasted (hot |
| | | indicates the sound | the water run | water) while brushing. |
| | | of tooth scrubbing, | while they brush. | Increment toothpaste |
| | | temperature sensor | | consumption |
| | | indicates hot water | | summation. Store |
| | | being used. | | outputs, implication, |
| | | | | actions in database. |
| Bathroom | Ambient, | Contact sensor | Someone is | Estimate shower water |
| Sink | Contact | detects distant | running the | usage from time |
| | | water running while | shower. | measurement. |
| | | ambient sensor | | Increment estimated |
| | | detects sounds | | shampoo, conditioner, |
| | | consistent with a | | and cleaning supply |
| | | shower operation. | | consumption. Store |
| | | | | outputs, implication, |
| | | | | actions in database. |
| Shower | Contact, | Contact sensor | Someone is | Estimate shower water |
| Head | Temperature | detects water | running the | and energy usage from |
| | | running, | shower using | time measurement. |
| | | temperature sensor | cold, warm, or | Increment estimated |
| | | estimates percent of | hot water. | shampoo, conditioner, |
| | | water that is heated. | | and cleaning supply |
| | | | | consumption. Store |
| | | | | outputs, implication, |
| | | | | actions in database. |
| Shower | Ambient | Ambient detects the | Shower has leaky | Alert user to shower |
| Head | | sound of water | valve or has not | condition. Store |
| | | droplets hitting the | been properly | outputs, implication, |
| | | floor | shut off. | actions in database. |
| Shower | Contact, | Temperature sensor | Indicates possible | Alert user to potential |
| Head | Temperature | detects continuous | hot water leak or | valve or leak problem. |
| | | warmth at shower | valve not closed. | Store outputs, |
| | | head. | | implication, actions in |
| | | | | database. |
| Kitchen | Contact, | Contact sensor | Water is being | Provide reports to users |
| Sink | Temperature | indicates water is | used in the | of water consumption |
| | | being consumed, | kitchen. Estimate | and degree of hot water |
| | | temperature sensor | percentage of hot | usage. Recommend |
| | | differentiates hot | water vs. cold | dish washer usage to |
| | | from cold running | water. | decrease total water |
| | | water. | | consumption. |
| | | | | Increment kitchen sink |
| | | | | soap consumption. |
| | | | | Store outputs, |
| | | | | implication, actions in |
| | | | | database. |
| Kitchen | Ambient, | Contact sensor | Dishwasher was | Analytics determine |
| Sink/ | Contact, | indicates water | started before the | how long to run hot |
| Dishwasher | Temperature | running, ambient | hot water was run | water prior to |
| | | sensor indicates the | sufficiently to | dishwasher start and |
| | | sound of | feed hot water for | notify user to |
| | | dishwasher | proper cleaning. | remember. Increment |
| | | beginning fill cycle, | | dishwasher soap and |
| | | temperature sensor | | rinse agent |
| | | indicates cold water | | consumption |
| | | in the hot water | | summation. Store |
| | | line. | | outputs, implications, |
| | | | | actions in database. |
| Washing | Ambient, | Contact sensor | Washing machine | Alert user of out-of- |
| Machine | Contact | detects non- | out of balance | balance condition. Store |
| | | waterflow | and perhaps | outputs, implications, |
| | | intermittent sounds, | stopped. | actions in database. |
| | | ambient sensor | | |
| | | detects ‘banging’ | | |
| | | sound or buzzer | | |
| Washing | Ambient, | Contact sensor | 1) Washer does | 1) Notify user that more |
| Machine | Contact, | indicates only hot | not receive hot | soap may be needed |
| | Temperature | water valve open, | water until x | because water is not at |
| | | ambient sensor | seconds after | recommended |
| | | indicates the sound | starting fill and | temperature. Notify |
| | | of washer | may not be | soap manufacturer of |
| | | beginning fill cycle, | cleaning at the | usage issues. 2) Notify |
| | | temperature sensor | desired | user that energy is |
| | | indicates cold water | temperature. 2) | being wasted. |
| | | in the hot water | Washer always | Increment consumption |
| | | line. | uses hot water | data and store outputs. |
| | | | only. | |
| Toilet | Contact | Contact sensor | Toilet was | Provide reports to users |
| | | detects flush | flushed and | for water consumption |
| | | activity. | estimate water | and toilet paper usage. |
| | | | usage, cleaning | Increment consumption |
| | | | supplies, and | data and store outputs. |
| | | | toilet paper | |
| | | | usage. | |
| Toilet | Contact | Contact sensor | Fill valve is leaky | Alert user to toilet leak. |
| | | detects continuous | following flush. | Estimate water wastage. |
| | | low flow | May occur | Trigger possible |
| | | | occasionally or | replacement kit or |
| | | | continuously. | service call. Store |
| | | | | outputs. |
| Toilet | Contact | Contact sensor | Flapper valve is | Alert user to toilet leak. |
| | | detects occasional | leaky. May occur | Estimate water wastage. |
| | | short-fill valve | occasionally or | Trigger possible |
| | | openings | continuously. | replacement kit or |
| | | | | service call. Store |
| | | | | outputs. |
| Toilet | Ambient, | Ambient sensor | Likely that male | Do not increment toilet |
| | Contact | detects seat lifting | has urinated from | paper consumption. |
| | | (optional) and loud | a standing | Increment toilet |
| | | urination sounds. | position. | cleaning product |
| | | Contact sensor | | consumption. Store |
| | | detects toilet flush. | | outputs, implications, |
| | | | | actions in database. |
| Toilet | Ambient, | Ambient sensor | Likely that male | Alert selected users of |
| | Contact | detects seat lifting | has urinated from | failure to flush. Do not |
| | | (optional) and loud | a standing | increment toilet paper |
| | | urination sounds. | position, but did | consumption. |
| | | Contact sensor | not flush | Increment toilet |
| | | detects NO toilet | | cleaning product |
| | | flush. | | consumption. Store |
| | | | | outputs, implications, |
| | | | | actions in database. |
| Toilet | Ambient, | Ambient sensor | Likely that a | Increment toilet paper |
| | Contact | detects seat shifting | female has | consumption. |
| | | and low-volume | urinated from a | Increment toilet |
| | | urination sounds. | seated position. | cleaning product |
| | | Contact sensor | | consumption. Store |
| | | detects toilet flush. | | outputs, implications, |
| | | | | actions in database. |
| Toilet | Ambient, | Ambient sensor | Likely that a | Increment toilet paper |
| | Contact | detects seat shifting | defecation has | consumption. |
| | | and low-volume | occurred. | Increment toilet |
| | | urination sounds | | cleaning product |
| | | plus ‘plopping’ | | consumption. Possible |
| | | sounds and/or | | release of aroma from |
| | | flatulence. Lengthy | | external device. Store |
| | | delay before | | outputs, implications, |
| | | contact sensor | | actions in database. |
| | | detects toilet flush. | | |
| Toilet | Ambient | Ambient sensor | Estimate toilet | Increment toilet paper |
| | | detects the sound of | paper | consumption. Detection |
| | | the toilet paper | consumption. | of spindle rotation |
| | | spindle rotating. | | improves accuracy of |
| | | | | other toilet paper |
| | | | | estimations. Store |
| | | | | outputs, implications, |
| | | | | actions in database. |
| Outdoor | Contact | Contact sensor | Estimate water | Notify user if usage |
| faucet | | detects water | consumption and | patterns are unusual. |
| | | running. | compare usage | Alert user for excessive |
| | | | patterns to | water consumption. |
| | | | historical data. | Store outputs, |
| | | | | implications, actions in |
| | | | | database. |
| Outdoor | Contact, | Contact sensor does | Faucet is at risk | Alert user of potential |
| faucet | Temperature | not detect any | of freezing or has | freezing or problems. |
| | | water flow, | frozen. | Store outputs, |
| | | temperature sensor | | implications, actions in |
| | | detects freezing | | database. |
| | | temperatures | | |
| Drain Vent | Ambient | Ambient sensor | Analytics use | Correlate with normal |
| Pipe | | detects the gurgling | pattern matching | usage patterns and alert |
| | | sound of a distant | and | or notify user if |
| | | drain running | fingerprinting to | abnormal water usage is |
| | | | determine the | occurring. Store |
| | | | source of the | outputs, implications, |
| | | | draining water. | actions in database |
| | | | | Store outputs, |
| | | | | implications, actions in |
| | | | | database |
| Drain Vent | Ambient | Ambient sensor | Analytics | Alert the user of the |
| Pipe | | detects an unusual | indicate a high | possible drain blockage. |
| | | ‘glugging’ sound. | probability of a | Augment with |
| | | | partial drain | recommendations for |
| | | | blockage. | clearing. Store outputs, |
| | | | | implications, actions in |
| | | | | database. |
| Drain Vent | Ambient | Ambient sensor | Analytics | Alert the user of the |
| Pipe | | detects no drain | indicate a high | possible full drain |
| | | sound while other | probability of a | blockage. Augment |
| | | sensors indicate | full drain | with recommendations |
| | | that water is | blockage. | for service. Store |
| | | flowing. | | outputs, implications, |
| | | | | actions in database. |
| Water | Contact | Contact sensor | Analytics | Notify the user that |
| Softener | | indicates water | indicate that | regeneration is in |
| System | | flowing into the | water softener | process. Increment |
| | | regeneration tank. | regeneration is in | regeneration |
| | | | process. | consumables. Store |
| | | | | outputs, implications, |
| | | | | actions in database. |
| Any Sink | Contact, | Either or both | Faucet is either | Alert user of not-closed |
| or Valve | Ambient | sensors detect the | not closed or is | valve or of leak. |
| | | sound of water | leaking. | |
| | | squeezing through a | | |
| | | small opening. | | |
| Pool or Spa | Contact | Detects the run- | Indicates usage | Estimate pool chemical |
| Pump | | time durations of | of pool | usage and increment |
| | | the pool pump. | chemicals. | consumption data. Store |
| | | | | outputs, implications, |
| | | | | actions in database. |
| Pool or Spa | Contact, | Detects the run- | Indicates usage | Provide users with pool |
| Pump | Temperature | time durations of | of pool chemicals | temperature reports. |
| | | the pool pump and | with increased | Estimate pool chemical |
| | | pool water | accuracy. | usage and increment |
| | | temperature. | | consumption data. |
| | | | | Estimate water |
| | | | | evaporation rate. Store |
| | | | | outputs, implications, |
| | | | | actions in database. |
| Water | Contact, | Detects usage and | Indicates how | Provides users with |
| Heater | Temperature | output temperature. | much energy is | energy usage reports |
| | | | used to heat | and alerts for low |
| | | | water and alerts if | temperature outputs or |
| | | | there are low | continuous usage from |
| | | | output | possible leaky valves or |
| | | | temperatures. | plumbing leak. |
| Dishwasher | Contact, | Detects time that | Indicates | Alert users regarding |
| | Temperature | water is being | approximate | insufficient water |
| | | drawn and percent | water | temperature. Notify |
| | | of time the water is | temperature used | manufacturers about |
| | | hot. | for dishwasher | usage practices. Store |
| | | | input. | outputs and monitor |
| | | | | trends. |

### Toilet Paper Utilization Estimation

Measuring consumption of toilet paper unobtrusively is a benefit of the sensor system. Because the sensors monitor valve activity as well as ambient sounds, tuning the DSP to recognize sounds of toilet paper consumption or enhancing the sounds of the toilet paper spindle provides improved accuracy for utilization estimates. In one embodiment, a standard toilet paper spindle supported on each end and compressed into a bracket attached to a wall or cabinet is replaced with a custom toilet paper spindle that makes noise as it is rotated. The noise can be generated by loose materials (e.g., BBs, ball bearings, or plastic pellets) rattling around inside the spindle as the toilet paper is consumed. Using an ambient sound sensor with the associated DSP tuned to the sound of the rotating spindle, the system can detect toilet paper roll rotations as a proxy for toilet paper consumption. In another embodiment, a custom insert fits snugly into the cardboard or plastic toilet paper core. In one embodiment, a custom insert is designed with double walls that contain loose materials (e.g., a BBs, ball bearings, or plastic pellets) that make noise while the roll is turning to dispense the toilet paper. Using an ambient sound sensor with the associated DSP tuned to the sound of the rotating core insert, the system can detect toilet paper roll rotations as a proxy for toilet paper consumption. In one embodiment, the toilet paper core insert has a protrusion that rattles against a standard spindle as the toilet paper is dispensed. The advantage of the core insert is that the usage sounds are created for all horizontal spindle installations regardless of the toilet paper mounting scheme.

There are several methods for dispensing toilet paper in today's bathrooms and each can be accommodated with either sound-making spindle or a sound-making core insert. Table 4 shows some of the more common toilet paper dispenser types and how a custom spindle or core insert can be used to estimate toilet paper consumption. For each mounting type, an associated adapter type(s) is shown in the adjacent column, if needed. The adapter provides enhanced ambient sounds which can be selected by the DSP for increased accuracy in determining estimated toilet paper usage.

TABLE 4
Common Toilet Paper Dispenser Schemes and
Usage Estimation System Configurations

| | | | Quality of Usage |
|---|---|---|---|
| No. | Mounting Type | Adapter Type | Estimation |
| 1 | A horizontal piece of wire mounted on a | Core Insert | Good |
| | hinge, hanging from a door or wall | | |
| 2 | A horizontal axle recessed in the wall | Custom Spindle | Good |
| | | Core Insert | |
| 3 | A vertical axle recessed in the wall | Custom Spindle | Poor |
| | | Core Insert | |
| 4 | A horizontal axle mounted on a | Custom Spindle | Excellent |
| | freestanding frame | Core Insert | |
| 5 | A freestanding vertical pole on a base | Custom Spindle | Poor |
| | | Core Insert | |
| 6 | A wall mounted dispensing unit, usually | Custom Spindle | Good |
| | containing more than one roll. This is | Core Insert | |
| | used in the commercial/away-from- | | |
| | home marketplace | | |
| 7 | A wall mounted dispensing unit with | None | Poor |
| | tissue interleaved in a “S”-type fold so | | |
| | the user can extract the tissue one sheet | | |
| | at a time | | |

The dispenser types shown above typically include a custom adapter type to generate a sound as toilet paper is being consumed. In one embodiment, the DSP is tuned for maximum sensitivity to the sound of toilet paper being rustled or handled, hence no adapter may be needed. In the case of No 7 in the table, there is no spindle nor toilet paper core. In this case the only way for the system described herein to detect the usage of folded paper is by tuning the DSP to be sensitive to the sound of toilet paper sheet removal from the wall mounted folded paper dispenser.

### Toilet Leak Detection and Remediation

The average leaky toilet can waste about two hundred gallons of water per day and over 6,000 gallons per month costing between $50 and $95 per month of wasted water for one leaking toilet. Typically, there are three primary modes of leaking toilets: 1) the fill valve is not properly adjusted and does not close until after there is some water flowing into the overflow pipe; 2) the fill valve is leaky and continues to leak water into the tank which runs into the overflow pipe; and 3) the tank flapper valve leaks causing the fill valve to occasionally open and re-fill the tank with water.

For cases 1) and 2) above, the sensor may be configured to detect low flow sounds continuously following a full flush sound. For example, the detected sound may match the pattern of the sound that normally occurs just prior to the valve shutting off completely in a healthy toilet. The calibration sounds are used to determine one possible sound fingerprint for the “just prior to cut-off” valve sounds although any continuous low-flow sounds may indicate a fill valve problem. Once the analytics determine that the sounds imply a leaky fill valve, policy determines the next steps of alerting or alarming the user and making recommendations for re-adjusting the valve (case 1) or purchasing and replacing the fill valve assembly (case 2). The valve sounds may be distinct enough that the valve type is identified by the sound of the low-flow condition and normal flush condition. In this case, the system may recommend a replacement valve of the same type as is indicated by the valve sounds and other ancillary information which may be recorded during setup, calibration and/or other correspondence with the user. In one embodiment, the system may automatically send replacement parts to the user as soon as the leak is detected. In one embodiment, the system send a message via the user interface which may be on a computer or mobile device such as a phone or tablet, wherein the message describes the recommended replacement valve and prompts the user to order the replacement valve.

In general, with respect to fixtures, toilets, and appliances, in some embodiments, analysis of ambient sounds and contact sounds (captured by the tri-sensor or other sensors) by the central computer system may result in diagnosis of a malfunction and the part which is responsible for the malfunction (i.e., a leaky valve, washer, flapper, etc.). This facilitates the central computer system messaging the user associated the fixture/toilet/appliance which is malfunctioning with either or both of a notification about the suspected malfunction and a recommended part to replace which will resolve the malfunction (along with, in some instances, an internet link at which can complete the purchase transaction or to a repair person who can effect a repair).

### Interactive Replenishment and Remediation

By using consumption measurements, valve-oriented leak detection, and appliance sound monitoring, the system can provide the user with automatic or suggested replenishment products or remediation parts. For example, if the system uses the analyzed sounds and estimates that tooth brushing has occurred over a threshold amount (e.g., >95 times), the computer policy determines whether to automatically send replenishment toothpaste, or to send a message via the user interface asking the user if they are ready for a replenishment. The message to the user may also request feedback on how much product has been consumed since the last refill or message as a way to improve the accuracy of the consumption estimations.

In another example, the sounds of a dishwasher may indicate that more than a threshold of cycles (e.g., >95) has occurred since the last replenishment of rinsing agent. Since the usage of a consumable such as rinse agent is well determined by dishwasher cycle count, an automatic replenishment is easily supplied. In this case, the user may receive notifications that automatic replenishment is in process and would they like the same product or a substitute product for this replenishment cycle. Interactions with the user also allows for collection of survey information regarding how a product is working or how a given product compares to competitive products.

In the cases of dishwashers and washing machines, the system may gather water temperature information and, using pre-programmed policy, determine that input water temperature is not optimal for the product being used. For example, it is commonly recommended that clothes washing detergent used is increased for cold water washes instead of hot water washes. Additionally, some detergents work better in cold water than others. Knowing the water temperatures entering the machine provides information that can guide the user to the proper products and the amount of product being used. Interaction with the user via the user interface can both educate the user for better consumption and product usage as well as interact with user to provide improved system accuracy and aid suppliers/vendor/manufacturers in product design, messaging, and branding.

Some consumption measurements are more difficult and will require more interaction with the user. For example, when detecting shower sounds from a distance it may be difficult to discern who is in the shower, which products are being consumed and how much of those products are being consumed. A rough estimate of consumption may lead to opportunities for user interface interactions with the user about evaluating or ordering consumable products. As information is gathered from the user, the metadata across all platforms becomes more useful and better consumption estimates become possible. Also, user interactions allow opportunities for product advertising and special offers.

In another example, consumption may take place when it is not expected, such as when the user or family is away on a vacation. In this case, the user may tell the system that the house or facility will be unoccupied and if any consumption or leak occurs to send a alarm to the users mobile device. In this case, the consumption measurements act as an alarm system for detecting unexpected sounds or consumptions. The computer policy may even instruct the ambient sound sensors to bypass the DSP processing and allow full-spectrum audio to pass to the central processor system during the “away” interval.

In another example, using the consumption measurement sensors in a rental house or apartment may detect the excessive use of water or consumables indicative of a large number of people in the space and possibly a prohibited party or large gathering. In this case, the computer policy may send an alert to the owner of the property that excessive consumption is taking place. Ambient sound sensors may also be triggered by excessive noise and hence may aid in determining that prohibited activities are taking place.

### CONCLUSION

The examples set forth herein were presented to explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular aspects, features, structures, or characteristics of any embodiment may be combined in any suitable manner with one or more other aspects, features, structures, or characteristics of one or more other embodiments without limitation.

What is claimed is:

1. A method of estimating water consumption of a fixture which uses water, the method comprising:
capturing measurements of at least two of ambient sound, contact sound, and temperature via a sensor assembly disposed proximate to the fixture;
determining from the captured measurements both a number of uses of the fixture and a duration of use each of the uses of the fixture; and
estimating, based on the number of uses and duration of the uses, water consumed by the fixture over a period of time.

2. The method of claim 1, further comprising:
sending a message via a user interface to a user associated with the fixture, wherein the message includes the estimation of water consumed by the fixture and a best practice to reduce consumption of water from the estimated water consumption, wherein the best practice is selected based upon the captured measurements.

3. The method as recited in claim 1, wherein the capturing measurements of at least two of ambient sound, contact sound, and temperature via a sensor assembly disposed proximate the fixture comprises:
capturing measurements of at least two of ambient sound, contact sound, and temperature via the sensor assembly disposed proximate the fixture, wherein the fixture is one of a sink, a tub, and a shower.

4. The method as recited in claim 1, wherein the capturing measurements of at least two of ambient sound, contact sound, and temperature via a sensor assembly disposed proximate the fixture comprises:
capturing measurements of at least two of ambient sound, contact sound, and temperature via the sensor coupled to a water supply line of the fixture.

5. The method as recited in claim 1, wherein the capturing measurements of at least two of ambient sound, contact sound, and temperature via a sensor assembly disposed proximate the fixture comprises:
capturing measurements of at least two of ambient sound, contact sound, and temperature via the sensor coupled to a drainpipe of the fixture.

6. A method of estimating water consumption of an appliance which uses water, the method comprising:
capturing measurements of at least two of ambient sound, contact sound, and temperature via a sensor assembly disposed proximate the appliance;
determining from the captured measurements both a number of uses of the appliance and a duration of use each of the uses of the appliances; and
estimating, based on the number of uses and duration of the uses, water consumed by the appliance over a period of time.

7. The method of claim 6, further comprising:
sending a message via a user interface to a user associated with the appliance, wherein the message includes the estimation of water consumed by the appliance and a best practice to reduce consumption of water from the estimated water consumption, wherein the best practice is selected based upon the captured measurements.

8. The method as recited in claim 6, wherein the capturing measurements of at least two of ambient sound, contact sound, and temperature via a sensor assembly disposed proximate the appliance comprises:
capturing measurements of at least two of ambient sound, contact sound, and temperature via the sensor assembly disposed proximate the appliance, wherein the appliance is one of a dishwasher, a refrigerator, an icemaker, and a washing machine.

9. The method as recited in claim 6, wherein the capturing measurements of at least two of ambient sound, contact sound, and temperature via a sensor assembly disposed proximate the appliance comprises:
capturing measurements of at least two of ambient sound, contact sound, and temperature via the sensor assembly disposed proximate the appliance, wherein the appliance is a faucet.

10. The method as recited in claim 6, wherein the capturing measurements of at least two of ambient sound, contact sound, and temperature via a sensor assembly disposed proximate the appliance comprises:
capturing measurements of at least two of ambient sound, contact sound, and temperature via the sensor coupled to a water supply line of the appliance.

11. The method as recited in claim 6, wherein the capturing measurements of at least two of ambient sound, contact sound, and temperature via a sensor assembly disposed proximate the appliance comprises:
capturing measurements of at least two of ambient sound, contact sound, and temperature via the sensor coupled to a drainpipe of the appliance.

12. A method of suggesting replacement of a consumable, the method comprising:
capturing measurements of at least two of ambient sound, contact sound, and temperature via a sensor assembly disposed proximate to consumption of the consumable, wherein at least some of the captured measurements are associated with characteristics of water used in conjunction with the consumable;
estimating from the captured measurements a number of uses of the consumable; and
responsive to a predetermined end-of-life threshold being crossed by the estimated number of uses of the consumable, sending a message via a user interface to a user associated with the consumable, wherein the message includes recommends a replacement for the consumable which if selected and authorized by the user will be consumable of being shipped to the user for arrival prior to the actual end-of-life of the consumable.

13. The method as recited in claim 12, wherein the estimating from the captured measurements a number of uses of the consumable comprises:
estimating a number of uses of toilet tissue.

14. The method as recited in claim 12, wherein the estimating from the captured measurements a number of uses of the consumable comprises:
estimating a number of uses of a razor blade used for shaving.

15. The method as recited in claim 12, wherein the estimating from the captured measurements a number of uses of the consumable comprises:
estimating a number of uses of dishwasher soap.

16. The method as recited in claim 12, wherein the estimating from the captured measurements a number of uses of the consumable comprises:
estimating a number of uses of a toothbrush.

17. The method as recited in claim 12, wherein the estimating from the captured measurements a number of uses of the consumable comprises:
estimating a number of uses of toothpaste.

18. The method as recited in claim 12, wherein the estimating from the captured measurements a number of uses of the consumable comprises:
estimating a number of uses of washing machine detergent.

19. A method of suggesting replacement part for a toilet, the method comprising:
capturing measurements of at least two of ambient sound and contact sound via a sensor assembly disposed proximate to a toilet, wherein at least some of the captured measurements are associated with characteristics of water used in conjunction with the toilet;
determining from the captured measurements a malfunction of the toilet and a part responsible for the malfunction; and
sending a message via a user interface to a user associated with the toilet, wherein the message includes recommends a replacement part for the toilet which will resolve the malfunction.

20. A sensor assembly comprising:
a housing configured to couple with an external surface of one of a water supply line and a drainpipe;
an ambient microphone disposed within the housing, configured to capture measurements of ambient sound, and further configured to face away from either the water supply line or the drainpipe when the housing is coupled with the water supply line or the drainpipe;
a contact microphone disposed within the housing, configured to capture measurements of contact sound from one of a water supply line and a drainpipe, and further configured to contact either the water supply line or the drainpipe when the housing is coupled with the water supply line or the drainpipe;
a temperature sensor disposed within the housing and configured to capture temperature measurements of one of the water supply line and the drain pipe;
a radio and repeater module disposed within the housing and configured to wirelessly communicate with a computer system located apart from the sensor assembly; and
a controller communicatively coupled with the ambient microphone, the contact microphone, the temperature sensor, and the radio and repeater module, wherein the controller is configured to acquire captured measurements from the ambient microphone, the contact microphone, and the temperature sensor and provide the acquired captured measurements to the radio and repeater module for wireless communication to the computer system.
